(19) United States
(12) Patent Application Publication
(10) Pub. No.: US 2002/0152398 A1
(43) Pub. Date: Oct. 17, 2002

(54) Authorization process for the communication with a data bus

(76) Inventor: Rainer Krumrein, Backnang (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/098,624

(22) Filed: Mar. 18, 2002

(30) Foreign Application Priority Data
Mar. 16, 2001 (DE) 101 12 699.9

(51) Int. Cl. H04L 9/00

(52) U.S. Cl. 713/200

(57) ABSTRACT

In a process for selectively authorizing connection of external equipment to a data bus, data are exchanged between an equipment set and the data bus via a communication interface. Detection information for external equipment are provided to the data bus via a user interface, and transmitted to an authorization system assigned to the data bus. The authorization system determines whether a communication is to be established between the data bus and the equipment, based on the detection information reported to the data bus by way of the user interface, and on the detection information transmitted by the equipment.

### BACKGROUND AND SUMMARY OF THE INVENTION

This application claims the priority of German patent document 101 12 699.9, filed Mar. 16, 2001, the disclosure of which is expressly incorporated by reference herein.

The invention relates to a process for authorizing external equipment which can be selectively coupled to a data bus, and to a data bus suitable for implementing the process.

German Patent Document DE 198 53 000 A1 discloses a process and apparatus for supplying motor vehicles with data for operating control systems, including automatic controls. Wireless data communications equipment are provided between a vehicle and a control center to ensure that data can be transmitted, queried or exchanged. The latter data are used for operation, monitoring, updating and technical diagnosis or analysis, of, for example, the vehicle brake system, the chassis, the air pressure of the individual wheels, etc. The main focus of this process is on telediagnosis; that is, the wireless transmission of monitoring data acquired at regular time intervals by the control center. This process is limited to the communication with the control center.

German Patent Document DE 195 80 642 C2 discloses a process for authorizing and authentication of a base station. The process described there relates to portable telephones in general, as well as particularly to the validating of a communication connection between a communication device and an authorization device. The process comprises the following steps: Authentication of the base station with respect to the authorization device; authentication of the authorization device with respect to the base station; and validation of the communication connection between the base station and the authorization device when the base station and the authorization device have been authenticated. This process is described exclusively in connection with mobile radio communication systems.

It is an object of the present invention to provide a process which is suitable for the selectively coupling external equipment to a data bus.

Another object of the invention is to provide a data bus in which the authorization process can be implemented during coupling.

These and other objects and advantages are achieved by the process and apparatus according to the invention, in which by way of a data bus user interface, detection information for external equipment is provided to the data bus and transmitted to an authorization system associated with the data bus. The detection information of the external equipment is extracted from the data transmitted from the external equipment via the communication interface to the data bus, and the authorization system checks, based on this detection information and on detection information transmitted by the equipment, whether communication is to be established between the data bus and the additional equipment. The result of the check is made available as authorization information by the authorization system.

When the authorization information is positive, the authorization system must permit, by means of the communication interface, communication to the additional equipment which can be coupled externally, so that all components linked to the data bus, particularly the user interface, can exchange data by way of the data bus with the additional equipment. When the authorization information of the authorization system is negative, this authorization system will refuse the communication connection or, in the event of an already existing connection, terminate the connection. Furthermore, the authorization system makes available the status of the connection as connection information, so that this status can be displayed in a display in the vehicle or on a maintenance computer.

The detection information, the authorization information and the connection information of the external equipment which can be optionally coupled is stored by an authorization system assigned to the data bus in a storage device and is updated in the event of a change.

In the case of changes of the detection information for external equipment, the authorization system has to carry out a new check of the authorization and of the connection in order to be capable of, for example, withdrawing the authorization from an already authorized connection.

The process according to the invention can advantageously be used during the coupling of external equipment to the communication interface, in which case wireless data transmission is provided.

For security reasons, it may be necessary that the communication between the communication interface and the external equipment is encrypted. This relates particularly to the encryption of the detection information because knowledge of this information permits access to the data bus, and to the components linked to the data bus.

In addition, according to the invention, the data bus has an authorization system which analyzes, on the basis of the detection information reported to it for additional external equipment which is sought to be coupled and on the basis of the detection information transmitted by the external equipment, whether a data communication is to take place.

Based on analysis of the detection information, the authorization system establishes by means of the communication interface the connection to the external equipment, or terminates this connection.

In accordance with a further feature of the invention, the authorization system compares the detection information (particularly a password) transmitted from external equipment to the communication interface, with the detection information stored in a storage device (particularly with the password for the external equipment). In the event of a match, the authorization system will authorize the connection.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic view of a data bus for implementing the process according to the invention;

FIG. 2 is a table which shows data stored in a storage device in the process according to the invention, on the basis of which data an authorization can be implemented;

FIG. 3 shows data which, in the case of the authorization process according to the invention, are stored in a storage device for the individualization of the equipment optionally connected to the data bus.

### DETAILED DESCRIPTION OF THE DRAWINGS

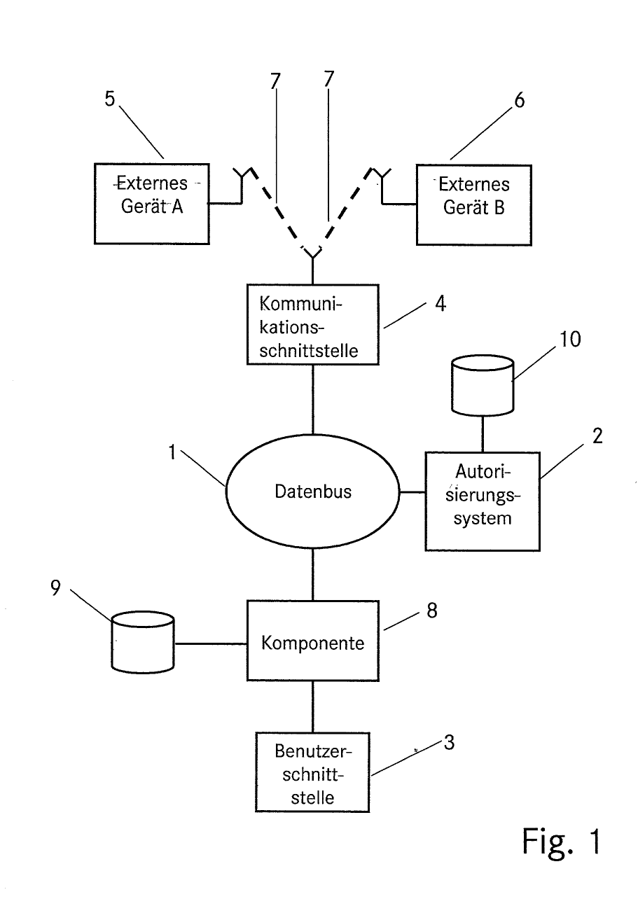

Referring to FIG. 1, data bus 1 is connected with an authorization system 2, a user interface 3 and a communication interface 4. Existing external equipment 5, 6, which can be optionally coupled, can establish a communication to the communication interface 4 by way of a wireless data transmission connection 7.

The data bus 1 can be provided as an optical MOST or D2B bus or as an electric CAN bus in a traffic device, particularly a motor vehicle. The user interface 3 may be constructed as a display in a vehicle dashboard and may be connected by means of a component 8 with the microcomputer and the storage device 9 in order to implement a data processing.

The authorization system 2 may be constructed as a control unit with a storage device 10 in order to carry out the system functions required for the process and to store the detection and status information of the coupling to the equipment 5, 6 which can be externally coupled.

For the more direct communication with the user interface 3, the authorization system 2 can also be functionally combined with the component 8 so that the data exchange between the user interface 3 and the authorization system 2 does not have to take place by way of the data bus 1.

The communication interface 4 comprises a control unit that is electrically connected with the data bus 1, and provides wireless data transmission (corresponding to Bluetooth, GSM or similar standards) with the equipment 5, 6 which can be externally coupled. The communication interface 4 transmits the detection information transmitted by the external equipment 5 or 6 to the data bus 1. The authorization system 2 linked to the data bus 1 compares this information with the detection information stored in the storage device 10; if it matches, and the authorization is therefore positive, the authorization system 2 initiates coupling of the external equipment 5 or 6 to the data bus, via communication interface 4.

External devices 5, 6 are mobile telephones, laptops, mobile personal digital assistants, headphones etc. This equipment 5, 6 sends detection information to the communication interface 4 of the data bus 1 in order to establish the connection. When the authorization has taken place, the equipment 5, 6 as required, can communicate with each device directly connected with the data bus 1. For example, a mobile telephone can exchange communication data, such as voice data, with a handsfree system at the data bus 1. Furthermore, for example, a laptop can use a telephone linked to the data bus as a modem or can exchange data with other components, such as a navigation system, etc., linked to the data bus.

The user interface 3 is used to output optical data and to input and output control information of the user. In particular, the user interface 3 permits the input of detection information for equipment 5, 6, as well as the indication of status information with respect to the authorization and the connection to this equipment.

The detection information contains at least one equipment identification code for the external equipment 5 or 6 and a password assigned to the external equipment 5 or 6. The authorization status indicates whether the external equipment set 5 or 6 is authorized to establish a communication connection to the data bus 1 (that is, whether the detection information for the external equipment set 5 or 6 is stored in the data memory of the authorization system 2 and a connection was already authorized once by the authorization system 2). The connection status indicates whether at that moment there is a connection to the external equipment set 5 or 6.

In a data memory 10, the authorization system 2 stores the detection information, the status of the authorization and the status of the connection to the equipment 5, 6. For storing these data, the authorization system 2 prepares a list (hereinafter, an “equipment list”) on the basis of the external equipment identifications as well as the corresponding status information. Once authorized by the authorization system 2, external equipment 5, 6 will not be deleted from the equipment list, even if no connection is available at the moment.

The authorization system 2 checks whether the detection information transmitted by the external equipment 5 or 6 to the communication interface 4 corresponds to the detection information already reported to it or requested by way of the user interface 3. As soon as the detection information of an exterior equipment 5 or 6 has been reported to the authorization system 2, it is stored in the data memory of the latter. If the authorization system 2 has no access to detection information for transmitting external equipment set 5 or 6, the external equipment set 5 or 6 is filed in the equipment list with the status of being not authorized and not connected.

If the match between transmitted detection information and detection information reported to the authorization system is positive (that is, the transmitted equipment identification and password are identical with the equipment identification and password reported to the authorization system), the authorization system 2 will authorize the connection. If the match is negative, no authorization will take place. The status for this equipment set 5 or 6 is correspondingly updated by the authorization system 2 in the equipment list in the data memory 10 to AUTHORIZED or NOT AUTHORIZED.

Only when the authorization is positive, will the authorization system 2 permit the establishment of a fixed connection with the external equipment, by means of the communication interface 4. When the connection has been established, the connection status will be updated by the authorization system 2 in the equipment list in the data memory 10 to CONNECTED. As a result, the external equipment set 5 or 6 has free access to the data bus 1 and can exchange data with the components connected to the data bus 1, particularly the user interface 3.

If a change of the detection information for an external device 5 or 6 is reported to the authorization system 2 by way of the user interface 3, the authorization process is restarted for and with the changed detection information. When the authorization is positive, the connection is either established or maintained. When the authorization is negative, the establishment of the connection is rejected or an existing connection is terminated, and the status is correspondingly updated in the equipment list. This process can be used, for example, when the authorization is to be withdrawn from an equipment set 5 or 6 authorized at the data bus 1. For this purpose, the password in the detection information for the corresponding external device 5 or 6 is changed by way of the user interface 3; thus, is set, for example to a void input.

Alternatively, an authorization system is situated in the device 5 or 6, and the data bus 1 must be capable of being authorized for access at this device 5 or 6. For this purpose, the detection information for the external equipment (the equipment identification and the password) must be reported to the authorization system 2 of the data bus. During establishment of communications, the communication interface 4 transmits the detection information of the data bus 1 to the external equipment. This detection information contains an equipment identification for the communication interface 4 of the data bus 1 and the password assigned to the device 5, 6. The device 5 or 6 receives the detection information transmitted by the communication interface 4 of the data bus 1, and can verify it by means of its authorization system. When the authorization by the device 5 or 6 is successful, the communication connection is permitted, and the status of the equipment list must be correspondingly updated. In this case, it should be taken into account that the authorization system of the device 5 or 6 can terminate the connection at any time. This applies particularly when the password for the connection with the data bus 1 is changed on the device 5 or 6 while this change is not also implemented on the authorization system 2 of the data bus 1. The process can be used when a connection is to be established to a device 5 or 6 which is not yet present in the equipment list. Reporting of this detection information to the authorization system 2 of the data bus 1 by way of the user interface 3 causes the authorization system 2 to initiate the establishment of a connection to the external equipment.

The authorization system 2 provides content of the equipment list of the user interface 3 for a display, either upon request, in the case of changes or cyclically, and can be updated.

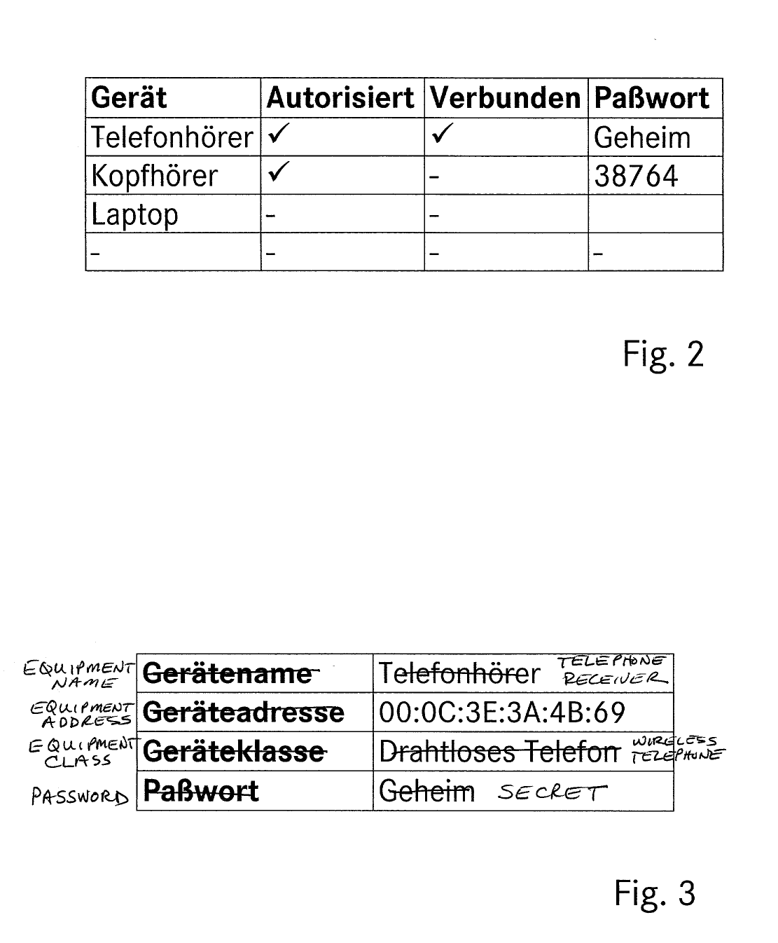

FIG. 2 is a representation of data corresponding to the content of the equipment list, stored in a storage device 10 (FIG. 1) in the process according to the invention. The equipment and password information represents the detection information for an authorization of communication by the authorization system 2. The AUTHORIZED status and the CONNECTED status are allocated by the authorization system 2. As illustrated in FIG. 2, the equipment set telephone receiver is authorized and connected with the data bus 1. The equipment set telephone receiver is authorized, but a connection cannot be established at the moment because this equipment set is, for example, not switched on. The equipment set laptop appears in the list because this equipment set has already transmitted detection information to the communication interface 4; it is therefore reachable and ready for the authorization. However, no detection information has yet been reported to the authorization system 2 and it could therefore not yet implement an authorization. Correspondingly, the equipment set laptop can also not be connected with the data bus 1.

FIG. 3 illustrates an example of a further individualization of the data in the equipment list, such as may be necessary, for example, if several devices 5, 6 having the same name want to be connected, and an identification on the basis of the device name is not sufficient. For example, the device with the name telephone receiver was distinguished by defining additional characteristics, such as the equipment address (the hardware address of the equipment set being used here), or the indication of an equipment class (here, a wireless telephone). These data must be reported by way of the user interface 3 to the authorization system 2 so that these data are stored in the equipment list.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A process for selectively authorizing the connection of external equipment to a data bus, by an exchange of data between an equipment set and the data bus via a communication interface, wherein:
detection information for an external equipment set is input to the data bus by way of a user interface;
the detection information is transmitted to an authorization system connected with the data bus;
detection information of the external equipment set is extracted from the data transmitted from the external equipment set via the communication interface to the data bus;
based on detection information input from the data bus via the user interface, and on the detection information transmitted from the equipment, the authorization system checks whether a communication is to be established between the data bus and the equipment set to be selectively coupled, and the result of the check is made available as authorization information; and
when the authorization information is positive, the authorization system permits communication to the equipment set, by means of the communication interface, whereby components linked to the data bus via the data bus exchange data with the external equipment.

2. The process according to claim 1, wherein the authorization system makes available the status of the communication as connection information.

3. The process according to claim 1, wherein the detection information, the authorization information and the connection information of the external equipment are stored by an authorization system assigned to the data bus and are updated in the event of changes.

4. The process according to claim 1, wherein in the event of a change of the detection information for external equipment, the authorization system implements a new check of the authorization.

5. The process according to claim 1, wherein the coupling of the external equipment to the communication interface takes place via wireless data transmission.

6. The process according to claim 1, wherein data transmission between the external equipment and the communication interface takes place in an encrypted mode.

7. A data bus having a communication interface and at least one component equipped with a microcomputer, wherein:
authorization information can be transmitted to the component via a user interface;
the component has a storage device for the storage of authorization data; and
data can be transmitted via the communication interface, from an external equipment set which can be optionally connected with the data bus;
wherein the data bus has an authorization system which analyzes whether a data communication is to be established, based on the detection information for external equipment stored in the storage device and on detection information transmitted by the external equipment.

8. The data bus according to claim 7, wherein detection information establishes or terminates the connection to the external equipment via the communication interface, based on an analysis of the detection information.

9. The data bus according to claim 7, further comprising a comparison device which compares the detection information transmitted from an external equipment set to the communication interface, with detection information for the external equipment set stored in the storage device and, in the case of a match, authorizes the connection.
